(19) United States
(12) Patent Application Publication
(10) Pub. No.: US 2025/0026302 A1
(43) Pub. Date: Jan. 23, 2025

(54) FLOOR MOUNTED LOWER LIMB RESTRAINT AIRBAG

(71) Applicant: TOYOTA JIDOSHA KABUSHIKI KAISHA, Aichi-ken (JP)

(72) Inventor: Toshiki IWAMA, Toyota-shi (JP)

(21) Appl. No.: 18/769,393

(22) Filed: Jul. 11, 2024

(30) Foreign Application Priority Data
Jul. 18, 2023 (JP) 2023-117121

(51) Int. Cl. B60R 21/274; B60R 21/00; B60R 21/02; B60R 21/2338; B60R 21/26; B60R 21/268

(52) U.S. Cl. CPC B60R 21/274; B60R 21/2338; B60R 2021/0004; B60R 2021/0051; B60R 2021/0053; B60R 2021/0213; B60R 2021/23386; B60R 2021/26058; B60R 2021/2685

(57) ABSTRACT

A floor mounted lower limb restraint airbag device includes: an airbag installed at a lower side of a floor of a vehicle cabin, configured to rupture the floor by being supplied with gas from an inflator during a vehicle head-on collision, and configured to be expanded and deployed toward at least knee regions of a passenger seated in a vehicle seat; and a tension member coupling an upper portion of the airbag with a support section provided at a lower side of the floor, the tension member rupturing the floor and deploying accompanying expansion and deployment of the airbag, and the tension member pulling the upper portion of the airbag at a vehicle rear side and relatively toward a vehicle lower side in a case in which at least the knee regions of the passenger, who begins to move toward a vehicle front side under inertia, are restrained by the airbag.

### CROSS-REFERENCE TO RELATED APPLICATION

This application claims priority under 35 USC 119 from Japanese Patent Application No. 2023-117121 filed Jul. 18, 2023, the disclosure of which is incorporated by reference herein in its entirety.

### BACKGROUND

### Technical Field

The present disclosure is related to a floor mounted lower limb restraint airbag device.

### Related Art

A hitherto known passenger protection device includes a right knee airbag and a left knee airbag that deploy from left-right sides of a passenger seated in a vehicle seat toward the knee regions of the passenger, and that respectively press a left and right knee regions (see, for example, Japanese Patent Application Laid-Open (JP-A) No. 2018-161963). The right knee airbag includes a right knee front contact face that contacts a front side of the right knee of the passenger in a deployed state, and the left knee airbag that includes a left knee front contact face that contacts a front side of a left knee of the passenger in a deployed state.

### SUMMARY

However, in the passenger protection device configured as described above, the left-right pair of knee airbags are both deployed toward central area in a seat width direction, and there is no reaction force surface present for each of the knee airbags.

This means that in a case in which, for example, there is a wide space present at a front side of the knee regions of the passenger seated in a vehicle seat, such as a front seat that has been moved a great distance toward the rear side, the knee regions (lower limbs) of a passenger beginning to move toward the front side under inertia during a vehicle head-on collision are not able to be appropriately restrained by the left-right pair of knee airbags.

Moreover, although a configuration might be considered in which, for example, a restraint object that will act as a reaction force surface for each knee airbag is caused to project out from the floor during a vehicle head-on collision, the vehicle seat is positioned at a variable locations in a front-rear direction, and so depending on a position of the vehicle seat, sufficient restraint force might not be obtained for the knee regions of the passenger. There is accordingly room for improvement in a lower limb restraint airbag device in a case in which there is a wide space present (no reaction force surface present) at a front side of the knee regions of the passenger seated in a vehicle seat.

The present disclosure accordingly obtains a floor mounted lower limb restraint airbag device capable of effectively restraining knee regions of a passenger even in a case in which there is a wide space present at a front side of the knee regions of the passenger seated in a vehicle seat.

A floor mounted lower limb restraint airbag device of a first aspect of the present disclosure includes an airbag and a tension member. The airbag is installed at a lower side of a floor of a vehicle cabin, and is configured to rupture the floor by being supplied with gas from an inflator during a vehicle head-on collision and configured to be expanded and deployed toward at least knee regions of a passenger seated in a vehicle seat. The tension member couples an upper portion of the airbag with a support section provided at a lower side of the floor, the tension member ruptures the floor and deploys accompanying expansion and deployment of the airbag, and pulls the upper portion of the airbag relatively toward a vehicle rear side and relatively toward a vehicle lower side in a case in which at least the knee regions of the passenger, who begins to move toward a vehicle front side under inertia, are restrained by the airbag.

In the first aspect, the airbag ruptures the floor of the vehicle cabin due to being supplied with gas from the inflator during a vehicle head-on collision, and is expanded and deployed toward at least the left and right knee regions of the passenger seated in the vehicle seat. Accompanying the expansion and deployment of the airbag, the tension member, which couples the upper portion of the expanded and deployed airbag with the support section provided at the vehicle lower side of the floor, ruptures the floor and deploys. The tension member pulls the upper portion of the airbag relatively toward the vehicle rear side and relatively toward the vehicle lower side in a case in which at least the knee regions of the passenger, who begins to move toward the vehicle front side under inertia, are restrained by the airbag.

The load from the knee regions of the passenger, who begins to toward the vehicle front side under inertia, is accordingly effectively borne by the airbag that is pulled by the tension member relatively toward the vehicle rear side and relatively toward the vehicle lower side. Namely, even though the airbag is pressed by the knee regions of the passenger toward the vehicle front side during passenger restraint, a reaction force is obtained by the tension member, and so the knee regions of the passenger are effectively restrained by compression deformation of the airbag. In the present disclosure, the knee regions of the passenger are accordingly effectively restrained by the airbag even in a case in which there is a wide space present and there is no reaction force surface present at a vehicle front side of the knee regions of the passenger seated in a vehicle seat. Note that reference to “during a head-on collision” also encompasses when a head-on collision is foreseen (predicted) to be unavoidable.

Moreover, a floor mounted lower limb restraint airbag device of a second aspect is the floor mounted lower limb restraint airbag device of the first aspect, wherein the airbag and the tension member are configured to be deployed by breaking rupture-break portions formed at the floor.

In the second aspect the airbag and the tension member break the rupture-break portions formed at the floor and deploy. The airbag and the tension member are accordingly deployed more smoothly than cases in which the break portions are not formed at the floor.

A floor mounted lower limb restraint airbag device of a third aspect is the floor mounted lower limb restraint airbag device of the first or second aspect, wherein the tension member is configured by a sheet tether that covers at least an upper half of a front wall of the expanded and deployed airbag from the vehicle front side.

In the third aspect, the tension member is configured from the sheet tether that covers at least the upper half of the front wall of the expanded and deployed airbag from the vehicle front side. The airbag is accordingly pulled relatively toward the vehicle rear side and relatively toward the vehicle lower side while held by the tension member over a wider surface area than cases in which the tension member is, for example, configured by a left-right pair of narrow elongated strap tethers. The load from the knee regions of the passenger, who has moved toward the vehicle front side under inertia, is accordingly more effectively borne by the airbag. Moreover, the sheet tether has a simple configuration made from a single piece of fabric, enabling a reduction in manufacturing cost to be achieved.

A floor mounted lower limb restraint airbag device of a fourth aspect is the floor mounted lower limb restraint airbag device of the first or second aspect, wherein the tension member is configured by a pair of strap tethers disposed spaced apart from each other in a vehicle width direction and having one-end portions thereof attached to the upper portion of the airbag and other-end portions thereof attached to the support sections.

In the fourth aspect, the tension member is configured by the pair of strap tethers including the one-end portions thereof attached to the upper portion of the airbag and the other-end portions thereof attached to the support sections. This means that a more compact tension member can be achieved than, for example, cases in which the tension member is configured by a sheet tether having a wide width, enabling a commensurate reduction in manufacturing cost.

A floor mounted lower limb restraint airbag device of a fifth aspect is the floor mounted lower limb restraint airbag device of any one of the first to fourth aspects, wherein the inflator is a single inflator provided so as to supply the gas to a central portion, in a vehicle width direction, of the airbag.

In the disclosure of the fifth aspect, the inflator is the single inflator provided so as to supply the gas to the central portion, in the vehicle width direction, of the airbag. The shape of the airbag is accordingly simpler than cases in which the inflator is, for example, provided as a left-right pair of inflators.

A floor mounted lower limb restraint airbag device of a sixth aspect is the floor mounted lower limb restraint airbag device of any one of the first to fourth aspects, wherein the inflator is configured by a pair of inflators provided spaced apart from each other in a vehicle width direction so as to supply the gas respectively to two end portions, in the vehicle width direction, of the airbag.

In the disclosure of the sixth aspect, the inflator is configured by the pair of inflators provided so as to supply the gas respectively to two end portions, in the vehicle width direction, of the airbag. The airbag accordingly achieves full expansion and deployment at an earlier stage than, for example, in a case in which there is only a single inflator provided.

Moreover, a floor mounted lower limb restraint airbag device of the seventh aspect is the floor mounted lower limb restraint airbag device of any one of the first to sixth aspects, wherein a pre-tensioner mechanism to pull the tension member on being actuated is provided at the support section, and the pre-tensioner mechanism is configured so as to be actuated accompanying deployment of the airbag and the tension member in a case in which the vehicle seat is positioned at a specific position or further toward a vehicle rear side than the specific position.

In the disclosure of the seventh aspect, the pre-tensioner mechanism to pull the tension member on being actuated is provided at the support section, and the pre-tensioner mechanism is actuated accompanying deployment of the airbag and the tension member in a case in which the vehicle seat is positioned at the specific position or further toward the vehicle rear side that the specific position. Thus even when the vehicle seat is positioned at the specific position or further toward the vehicle rear side, the expanded and deployed airbag is able to be made to approach the knee regions of the passenger, and the knee regions of the passenger are effectively restrained.

A floor mounted lower limb restraint airbag device of an eighth aspect is the floor mounted lower limb restraint airbag device of any one of the first to seventh aspects, wherein the airbag includes: a first chamber that is configured to be expanded and deployed toward a vehicle upper side and toward a vehicle rear side by being supplied with the gas from the inflator, and a second chamber that is configured to be expanded and deployed toward at least the knee regions of the passenger by being supplied with the gas from the first chamber, and the tension member couples an upper portion of the first chamber to the support section.

In the disclosure of the eighth aspect, the airbag includes the first chamber that is configured to be expanded and deployed toward the vehicle upper side and toward the vehicle rear side by being supplied with the gas from the inflator, and the second chamber that is configured to be expanded and deployed toward at least the knee regions of the passenger by being supplied with the gas from the first chamber. The tension member couples the upper portion of the first chamber with the support section.

The load from the knee regions of the passenger, who begins to toward the vehicle front side under inertia, is accordingly effectively borne by the second chamber that is pulled relatively toward the vehicle rear side and relatively toward the vehicle lower side by the tension member through the first chamber. Namely, even when the second chamber is pressed by the knee regions of the passenger toward the vehicle front side during passenger restraint, a reaction force is obtained by the first chamber that is pulled by the tension member, and so the knee regions of the passenger are effectively restrained by compression deformation of the second chamber.

A floor mounted lower limb restraint airbag device of a ninth aspect is the floor mounted lower limb restraint airbag device of the eighth aspect, wherein the second chamber is configured to be expanded and deployed from an upper portion of a rear wall of the first chamber and is configured to restrain at least the knee regions of the passenger.

In the disclosure of the ninth aspect, the second chamber is expanded and deployed from the upper portion of the rear wall of the first chamber, and restrains at least the knee regions of the passenger. This means that an increase in capacity of the airbag is suppressed more than in a case in which configuration is with a single airbag (lacking a first chamber and a second chamber). Namely, an increase in the output of the inflator is suppressed, with a commensurate reduction in manufacturing cost.

Thus as described above, the present disclosure accordingly enables effective restraint of the knee regions of a passenger even in a case in which there is a wide space present at a vehicle front side of the knee regions of the passenger seated in a vehicle seat.

### BRIEF DESCRIPTION OF THE DRAWINGS

Exemplary embodiments of the present disclosure will be described in detail based on the following figures, wherein:

FIG. 1A is a schematic plan view illustrating a floor installed with a floor mounted lower limb restraint airbag device according to a first exemplary embodiment;

FIG. 1B is a schematic plan view illustrating a state in which an airbag door and tether door have opened at a floor installed with a floor mounted lower limb restraint airbag device according to the first exemplary embodiment;

FIG. 2A is a schematic plan view illustrating a deployment initial-stage state of an airbag of a floor mounted lower limb restraint airbag device according to the first exemplary embodiment;

FIG. 2B is a schematic plan view illustrating a deployment later-stage state of an airbag of a floor mounted lower limb restraint airbag device according to the first exemplary embodiment;

FIG. 3A is a schematic side view illustrating a deployment initial-stage state of an airbag of a floor mounted lower limb restraint airbag device according to the first exemplary embodiment;

FIG. 3B is a schematic side view illustrating a deployment later-stage state of an airbag of a floor mounted lower limb restraint airbag device according to the first exemplary embodiment;

FIG. 4A is a schematic plan view illustrating a deployment initial-stage state of an airbag of a floor mounted lower limb restraint airbag device according to a second exemplary embodiment;

FIG. 4B is a schematic plan view illustrating a deployment later-stage state of an airbag of a floor mounted lower limb restraint airbag device according to the second exemplary embodiment;

FIG. 5A is a schematic side view illustrating a deployment initial-stage state of an airbag of a floor mounted lower limb restraint airbag device according to the second exemplary embodiment;

FIG. 5B is a schematic side view illustrating a deployment later-stage state of an airbag of a floor mounted lower limb restraint airbag device according to the second exemplary embodiment;

FIG. 6A is a schematic plan view illustrating a deployment initial-stage state of an airbag of a floor mounted lower limb restraint airbag device according to a third exemplary embodiment;

FIG. 6B is a schematic plan view illustrating a deployment later-stage state of an airbag of a floor mounted lower limb restraint airbag device according to the third exemplary embodiment;

FIG. 7A is a schematic side view illustrating a deployment initial-stage state of an airbag of a floor mounted lower limb restraint airbag device according to the third exemplary embodiment;

FIG. 7B is a schematic side view illustrating a deployment later-stage state of an airbag of a floor mounted lower limb restraint airbag device according to the third exemplary embodiment;

FIG. 8A is a schematic plan view illustrating a deployment initial-stage state of an airbag of a floor mounted lower limb restraint airbag device according to a fourth exemplary embodiment;

FIG. 8B is a schematic plan view illustrating a deployment later-stage state of an airbag of a floor mounted lower limb restraint airbag device according to the fourth exemplary embodiment;

FIG. 9A is a schematic side view illustrating a deployment initial-stage state of an airbag of a floor mounted lower limb restraint airbag device according to the fourth exemplary embodiment;

FIG. 9B is a schematic side view illustrating a deployment later-stage state of an airbag of a floor mounted lower limb restraint airbag device according to the fourth exemplary embodiment;

FIG. 10A is a schematic side view illustrating a deployment initial-stage state of an airbag of a floor mounted lower limb restraint airbag device according to a fifth exemplary embodiment; and

FIG. 10B is a schematic side view illustrating a deployment later-stage state of an airbag of a floor mounted lower limb restraint airbag device according to the fifth exemplary embodiment.

### DETAILED DESCRIPTION

Detailed explanation follows regarding exemplary embodiments according to the present disclosure, with reference to the drawings. Note that for ease of explanation, where appropriate in the drawings arrow UP indicates an upward direction of a vehicle and vehicle seat, arrow FR indicates a forward direction of a vehicle and vehicle seat, and arrow RH indicates a right direction of a vehicle and vehicle seat. This means that in the following description, unless explicitly stated otherwise, reference to up and down, front and rear, and left and right directions indicate up and down, front and rear, and left and right directions of a vehicle and vehicle seat. Moreover, a left-right direction has the same definition as a vehicle width direction and seat width direction.

### First Exemplary Embodiment

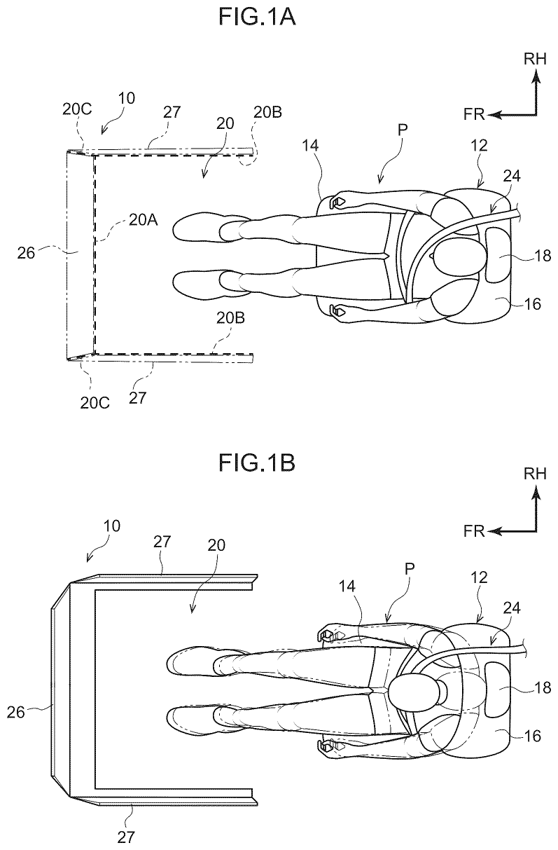

Description follows regarding a first exemplary embodiment. As illustrated in FIG. 1A to FIG. 3B, a passenger restraint device 10 is configured including a vehicle seat 12 and a floor mounted lower limb restraint airbag device 30 (hereinafter sometimes simply referred to as “lower limb restraint airbag device 30”) provided for the vehicle seat 12. Note that reference to “lower limb” indicates a lower side from knee regions of a passenger P and includes at least the knee regions and shin regions thereof.

The vehicle seat 12 is a front seat on a passenger seat side of a vehicle or a rear seat where a wide space in a front-rear direction is present at a seat front side, such as in a self-driving car or the like. The vehicle seat 12 includes a seat cushion 14 for a passenger to sit on (supporting the buttocks and thighs of the passenger), a seatback 16 that is provided at a rear side of the seat cushion 14 so as to be capable of swinging about an axial direction along a seat width direction and supporting the back of the passenger, and a headrest 18 that is provided at an upper end portion of the seatback 16 and is capable of being raised and lowered to support the head of the passenger.

Note that in each of the drawings, a crash test dummy (dummy person) serving as a model of a passenger (seated person) to be protected is illustrated in a seated state on the seat cushion 14 of the vehicle seat 12. The dummy person is, for example, a head-on collision crash test dummy (Hybrid III) America Adult Male 50 percentile (AM50). The dummy person is seated in a standard seated posture as stipulated by the crash test method, and the vehicle seat 12 is positioned at the standard set position corresponding to the seated posture. The dummy person is referred to as “passenger P” below.

Moreover, as illustrated in the drawings, the passenger P seated on the seat cushion 14 of the vehicle seat 12 is restrained in the vehicle seat 12 by a seatbelt provided at a seatbelt device 24. Note that the seatbelt device 24 is a three-point seatbelt device.

The lower limb restraint airbag device 30 is installed at a front side of the vehicle seat 12 and at a lower side of a floor (floor panel) 20 of a vehicle cabin. The lower limb restraint airbag device 30 includes an airbag 32, an inflator 28, and a module case (omitted in the drawings). The airbag 32 is normally in a folded state housed, together with the inflator 28, inside the module case. The module case is formed in a hollow substantially cuboidal shape and is disposed at a lower side of the floor 20 of the vehicle cabin.

The vehicle is provided with a control device (ECU) for controlling actuation of the inflator 28. The control device is electrically connected to the inflator 28 and to non-illustrated crash sensors (including a camera and the like), and is configured so as to be able to detect a vehicle head-on collision, or foresee (predict) that a head-on collision is unavoidable. The control device actuates the inflator 28 when a vehicle head-on collision is either detected of foreseen (hereafter referred to as “during a head-on collision”) based on information from the crash sensors.

The inflator 28 is, for example, a combustion or cold gas type of cylinder inflator having a substantially cylindrical shape, and is disposed orientated with its axial direction along the front-rear direction. The inflator 28 generates gas under actuation by the control device during a vehicle head-on collision. Note that a vehicle head-on collision state when the control device actuates the inflator 28 encompasses offset head-on collisions, such as oblique collisions and small overlap collisions, in addition to full overlap head-on collisions.

The airbag 32 ruptures the floor 20 with expansion pressure arising from being supplied with gas from the inflator 28, and is thereby deployed and expanded toward left and right knee regions and shin regions (at least the left and right knee regions) of the passenger P seated in the vehicle seat 12, and is formed in a substantially inverted L-shape in side view looking along the vehicle width direction.

Note that a tear line 20A is formed along a left-right direction as a rupture-break portion at the floor 20, and the airbag 32 breaks the tear line 20A and expands and deploys. Moreover, a portion that breaks out from the tear line 20A and rolls up toward the front side configures an airbag door 26.

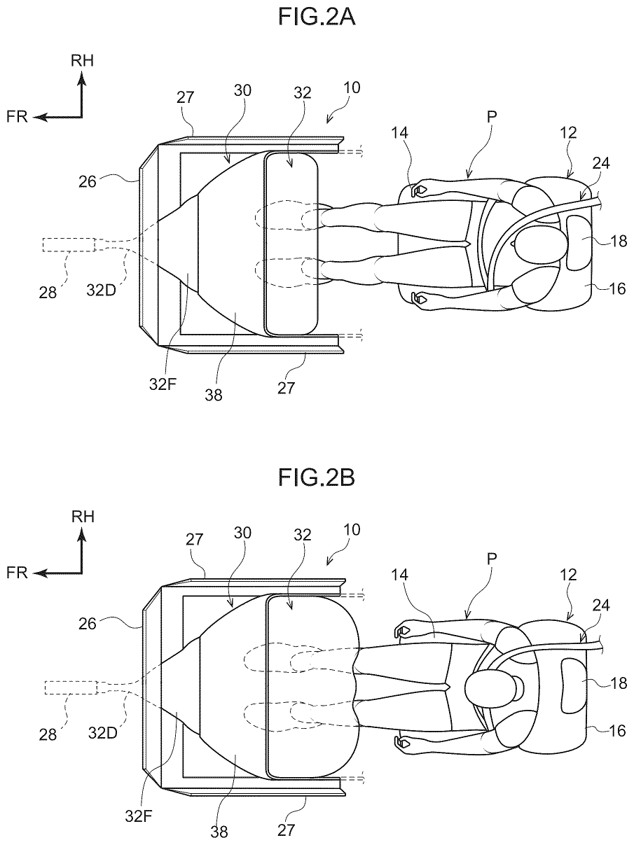

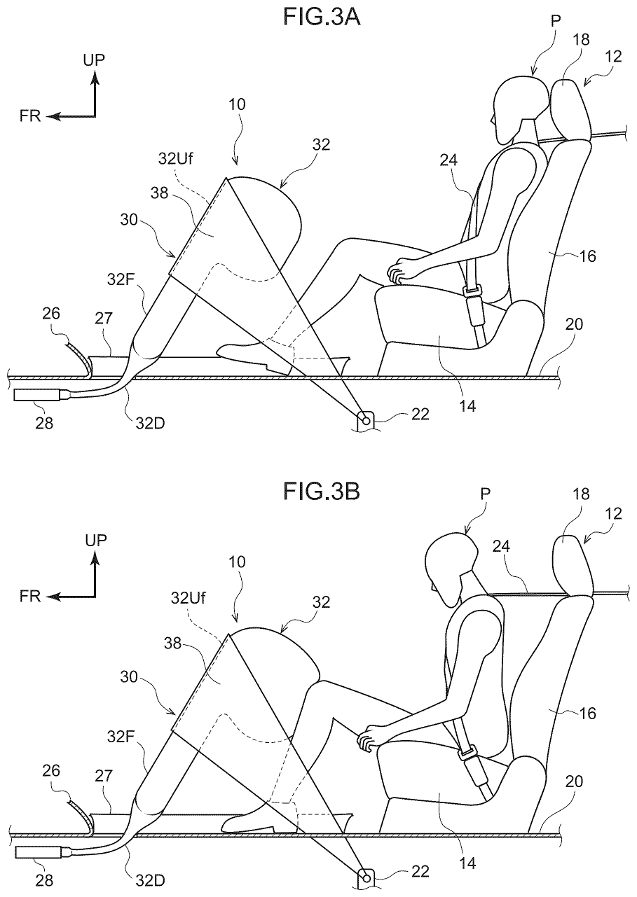

The expanded and deployed airbag 32 is formed with a size sufficient to be able to cover the left and right knee regions and shin regions of the passenger P from the front side (more precisely from a diagonal front and upper side). In other words, the expanded and deployed airbag 32 is formed with a width, height, and thickness capable of restraining at least the left and right knee regions from out of the left and right knee regions and shin regions of the passenger P, attempting to move toward the front side under inertia during a vehicle head-on collision. The airbag 32 is able to undergo compression deformation by being pressed by at least the left and right knee regions of the passenger P (scc FIG. 2B and FIG. 3B).

Note that the airbag 32 is formed in a bag shape by two sheets of base cloth being superimposed on each other and sewed together around peripheral edge portions thereof. The base cloth is configured, for example, from a polyamide or polyester based fabric. A single inflator 28 is provided to supply gas to a central portion in a left-right direction, of a lower end portion 32D of the airbag 32. This means that in plan view the airbag 32 is formed in a tapered shape having a width that gradually narrows on progression toward the lower end portion 32D.

Moreover, a sheet tether 38 is provided at a lower side of the floor 20 as a tension member that, accompanying the expansion and deployment of the airbag 32, ruptures a left-right pair of tear lines 20B formed at the floor 20 along the front-rear direction and deploys upward. The sheet tether 38 couples an upper end portion (upper portion) 32Uf of a front wall 32F of the expanded and deployed airbag 32 to a left-right pair of support sections 22, which are provided at a lower side of the floor 20 at a specific distance or greater further to the rear side than the module case.

The sheet tether 38 is configured so as to pull the upper end portion 32Uf of the front wall 32F of the airbag 32 relatively diagonally rearward and toward the lower side (toward the lower side at the rear side) when at least the left and right knee regions of the passenger P, beginning to move toward the front side under inertia, are restrained by the airbag 32. Namely, the airbag 32 is configured so as to obtain reaction force from the front side using the sheet tether 38.

Note that the sheet tether 38 is formed with a size after deployment sufficient to be able to cover at least an upper half of the front wall 32F of the expanded and deployed airbag 32 from the front side. The sheet tether 38 is attached to the airbag 32 by a peripheral area thereof being superimposed so as to cover the front wall 32F of the airbag 32, and being sewn to the front wall 32F.

In order to facilitate efficient pulling of the airbag 32 relatively diagonally rearward and toward the lower side, the sheet tether 38 is formed in side view with a substantially right angled triangle shape, with the right angle at a front end lower portion thereof. Namely, the sheet tether 38 is formed, for example, from a single piece of polyamide or polyester based fabric that has a substantially obtuse equilateral triangular shape when viewed face-on. Note that a portion that breaks out from the tear line 20B and rolls up toward the seat width direction outer side configures a tether door 27.

Moreover, as illustrated in FIG. 1, the tear line 20A and the left-right pair of tear lines 20B are formed contiguously to each other. Namely, the tear line 20A and the tear lines 20B are formed so as to make a substantially U-shape in plan view. In plan view, a tear line 20C is formed with a specific length diagonally toward the front and an outer side at respective sites where the tear line 20A intersects at right angles with the tear lines 20B. This results in a configuration in which the airbag door 26 and the tether door 27 roll up easily.

Explanation follows regarding the operation and advantageous effects of the lower limb restraint airbag device 30 according to the first exemplary embodiment configured as described above.

The inflator 28 is actuated under control of the control device during a vehicle head-on collision, and gas is ejected from the inflator 28. The gas ejected from the inflator 28 is supplied into the airbag 32. When this occurs, the tear line 20A formed in the floor 20 of the vehicle cabin receives expansion pressure of the airbag 32 and ruptures, and the airbag 32 is expanded and deployed toward the left and right knee regions and shin regions of the passenger P seated in the vehicle seat 12.

Moreover, accompanying the expansion and deployment of the airbag 32, the sheet tether 38, which couples the upper end portion 32Uf of the front wall 32F of the expanded and deployed airbag 32 to the left-right pair of support sections 22 provided at a lower side of the floor 20, ruptures the tear lines 20B formed at the floor 20 and deploys. The sheet tether 38 pulls the upper end portion 32Uf of the front wall 32F of the airbag 32 relatively diagonally rearward and toward the lower side when at least the left and right knee regions of the passenger P, beginning to move toward the front side under inertia, are restrained by the airbag 32. Namely, the sheet tether 38 forms a reaction force surface for the airbag 32.

This thereby enables load from at least the left and right knee regions of the passenger P, beginning to move toward the front side under inertia, to be effectively borne by the airbag 32 that is being pulled relatively diagonally rearward and toward the lower side by the sheet tether 38. Namely, even though the airbag 32 is pressed toward the front side by the left and right knee regions of the passenger P during passenger restraint, reaction force is obtained through the sheet tether 38, and so this enables the airbag 32 to undergo compression deformation and at least the left and right knee regions of the passenger P to be effectively restrained.

The first exemplary embodiment is accordingly able to effectively restrain at least the left and right knee regions of the passenger P even in a case in which there is a wide space present (there is no reaction force surface such as an instrument panel present) at the front side of the left and right knee regions and shin regions of the passenger P seated in the vehicle seats 12. In particular, the first exemplary embodiment is able to secure sufficient restraint force in a collision initial-stage.

Moreover, the sheet tether 38 covers at least the upper half of the front wall 32F of the expanded and deployed airbag 32 from the front side. The sheet tether 38 pulls the airbag 32 relatively diagonally rearward and toward the lower side while the airbag 32 is in a state held over a wider surface area than in a configuration in which, for example, the airbag 32 is pulled by a left-right pair of thin elongated strap tethers. This means that load from at least the left and right knee regions of the passenger P, who has moved toward the vehicle front side under inertia, can be borne more effectively by the airbag 32.

At least the left and right knee regions of the passenger P can accordingly still be effectively restrained even in a case in which the passenger P is not wearing a seatbelt, or is wearing a seatbelt but there is insufficient restraint by the lap belt of the seatbelt due to the passenger P being in a relaxed posture with the seatback 16 greatly reclined. The sheet tether 38 is also a simple configuration made from a single piece of fabric, enabling a reduction in manufacturing cost to be achieved.

As described above, the airbag 32 and the sheet tether 38 respectively break the tear line 20A and the tear lines 20B formed in the floor 20 and deploy. The airbag 32 and the sheet tether 38 are accordingly able to deploy more smoothly than cases in which the tear line 20A and the tear lines 20B are not formed in the floor 20.

Moreover, the inflator 28 is a single inflator provided so as to supply gas to the central portion, in the left-right direction, of the lower end portion 32D of the airbag 32. The shape of the airbag 32 is accordingly able to be formed in a simpler shape than cases in which, for example, the inflator 28 is configured by a left-right pair of inflators, i.e. the lower end portion 32D of the airbag 32 does not need to be formed in a bifurcated shape branching left and right as in the airbag 32 according to a second exemplary embodiment, described later.

### Second Exemplary Embodiment

Description follows regarding a second exemplary embodiment. Note that the same reference numerals are appended to similar sites to those of the first exemplary embodiment described above, and detailed explanation thereof (including of common operation and advantageous effects) will be omitted as appropriate.

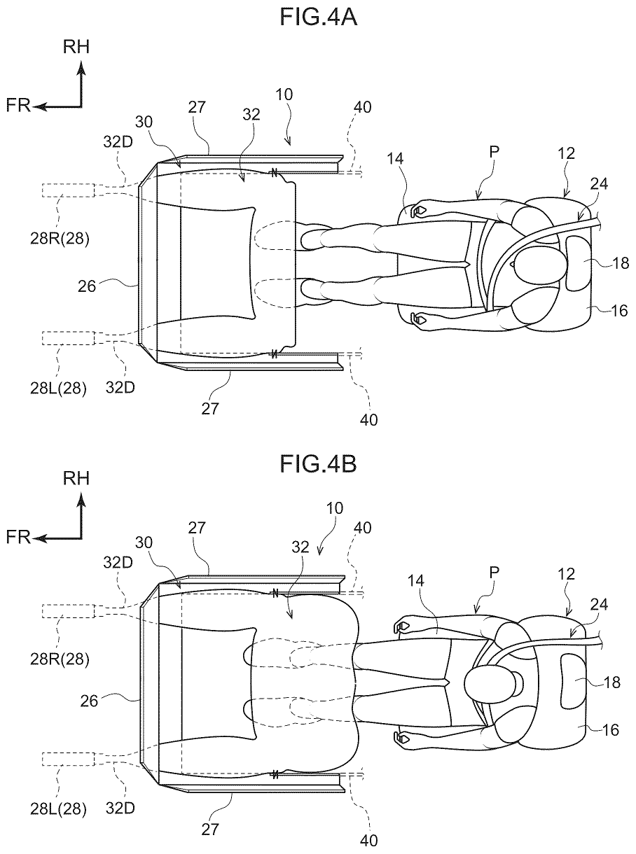

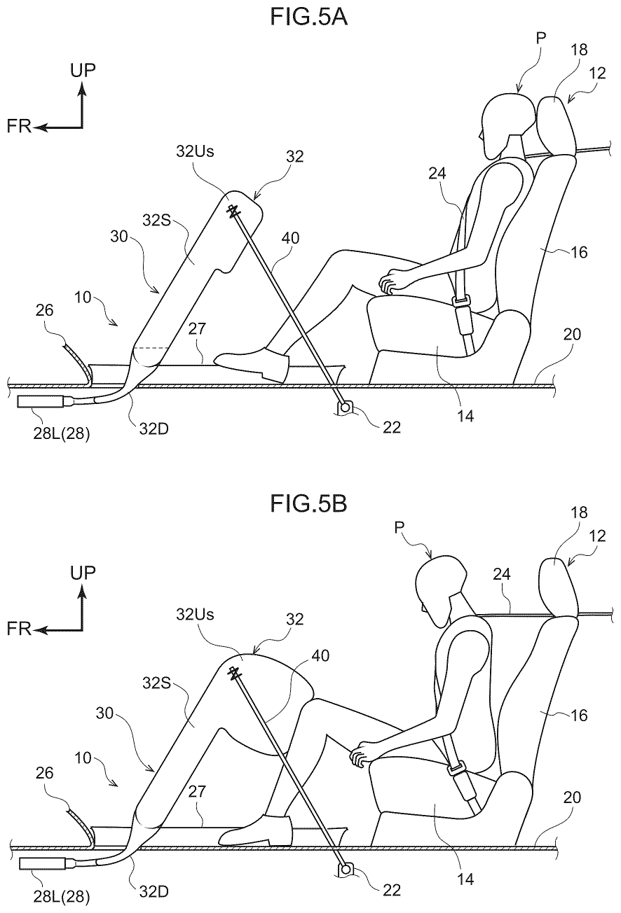

As illustrated in FIG. 4A to FIG. 5B, the second exemplary embodiment differs from the first exemplary embodiment described above in that a left-right pair of inflators 28 is provided so as to respectively supply gas to left-right direction end portions of a lower end portion 32D of an airbag 32, and in that the tension member is configured by a left-right pair of strap tethers 40 each having one-end portion respectively attached to upper end portions (upper portions) 32Us of left-right side walls 32S of the airbag 32, and having an other-end portion respectively attached to the left-right pair of support sections 22.

More specifically, the inflator 28 is provided as two individual inflators, an inflator 28L on the left side and an inflator 28R on the right side. The lower end portion 32D of the airbag 32 is accordingly formed in a bifurcated shape branching left and right in plan view. Namely, the inflators 28L, 28R are respectively connected to the left and right lower end portions 32D branching in the bifurcated shape of the airbag 32.

The thus configured second exemplary embodiment includes the left-right pair of inflators 28 provided so as to supply gas respectively to the left-right direction end portions of the airbag 32, namely the inflators 28L, 28R are respectively connected to the left and right lower end portions 32D branching in the bifurcated shape of the airbag 32, enabling the airbag 32 to achieve full expansion and deployment at an earlier stage than, for example, when there is only a single inflator 28 provided.

Moreover, the tension member is configured by the left-right pair of strap tethers 40. Namely, the one-end portions of the strap tethers 40 are respectively attached to the upper end portions 32Us of the left-right side walls 32S of the airbag 32, and the other-end portions of the strap tethers 40 are respectively attached to the left-right pair of support sections 22. This means that a more compact tension member can be achieved than, for example, cases in which the tension member is configured by a sheet tether 38 having a wide width, enabling a commensurate reduction in manufacturing cost.

### Third Exemplary Embodiment

Next description follows regarding a third exemplary embodiment. Note that the same reference numerals are appended to similar sites to those of the first exemplary embodiment and the second exemplary embodiment described above, and detailed explanation thereof (including of common operation and advantageous effects) will be omitted as appropriate.

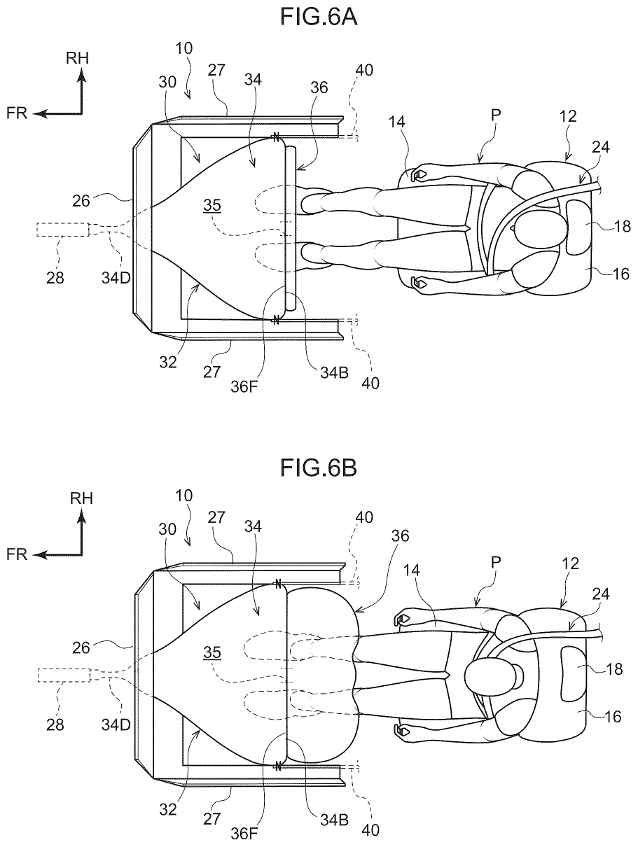

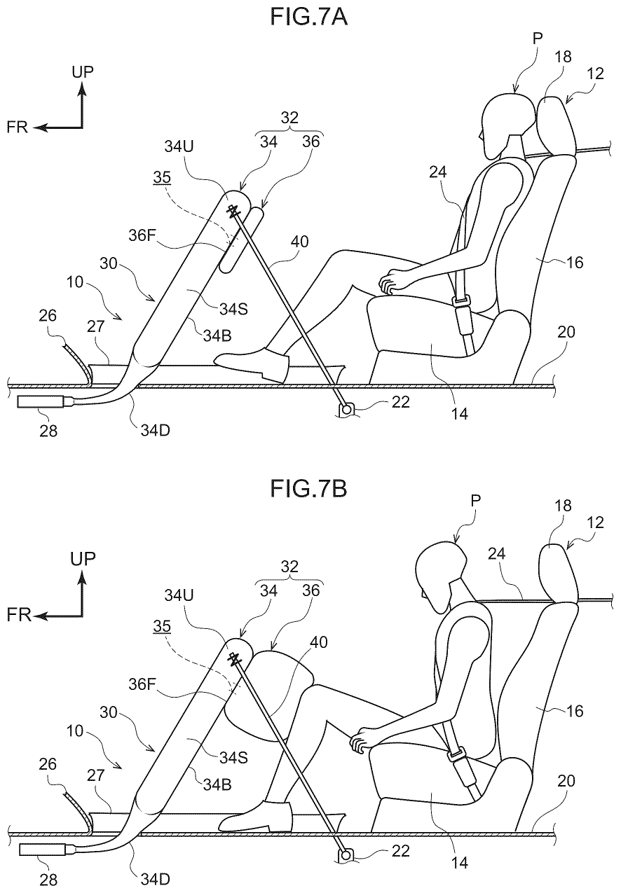

As illustrated in FIG. 6A to FIG. 7B, the third exemplary embodiment differs from the first exemplary embodiment described above in that the airbag 32 is includes a first chamber 34 that is configured to be expanded and deployed diagonally rearward toward an upper side (toward the upper side and toward the rear side) by being supplied with gas from the inflator 28, and includes a second chamber 36 that, by being supplied with gas from the first chamber 34, is configured to be expanded and deployed from an upper portion of the first chamber 34 diagonally rearward toward a lower side (toward the lower side and toward the rear side), namely toward left and right knee regions and shin regions (at least the left and right knee regions) of the passenger P. The third exemplary embodiment also differs from the first exemplary embodiment in that strap tethers 40 couple upper end portions (upper portions) 34U of left-right side walls 34S of the first chamber 34 to a left-right pair of support sections 22.

The second chamber 36 is provided on a side of a communication hole 35 at an upper portion of a rear wall 34B of the first chamber 34, and is supplied with gas from the first chamber 34 through the communication hole 35. Namely, the second chamber 36 is configured so as to be expanded and deployed toward the left and right knee regions and shin regions of the passenger P delayed by a specific timing with respect to the first chamber 34. After being expanded and deployed, the second chamber 36 is disposed at a front side of the left and right knee regions and shin regions of the passenger P.

Note that the communication hole 35 is provided at a substantially central portion, in a height direction, and at a substantially central portion, in a left-right direction, of the second chamber 36. The second chamber 36 is formed with a size after expansion and deployment sufficient to be able to cover at least the left and right knee regions of the passenger P from the front side (more precisely from a diagonally upward front side).

In other words, the expanded and deployed second chamber 36 is formed with a width, height, and thickness capable of restraining at least the left and right knee regions from out of the left and right knee regions and shin regions of the passenger P, beginning to move toward the front side under inertia, during a vehicle head-on collision, and the expanded and deployed second chamber 36 is able to undergo compression deformation by being pressed by at least the left and right knee regions of the passenger P.

Moreover, the first chamber 34 and the second chamber 36 are each formed in a bag shape by two sheets of base cloth being superimposed on each other and sewed together around peripheral edge portions thereof. The base cloth is configured, for example, from a polyamide or polyester based fabric. A front wall 36F of the second chamber 36 is then attached to the rear wall 34B of the first chamber 34 by sewing together at the periphery of the communication hole 35 formed, for example, in a circular shape.

The thus configured third exemplary embodiment is accordingly able to effectively bear the load from at least the left and right knee regions of the passenger P, who has moved toward the front side under inertia, using the second chamber 36 that is being pulled relatively diagonally rearward and toward the lower side by the strap tethers 40 through the first chamber 34. Namely, even though the second chamber 36 is pressed forward by the left and right knee regions of the passenger P during passenger restraint, a reaction force is obtained from the first chamber 34 that is being pulled by the strap tethers 40, enabling the second chamber 36 to be deformed by compression and at least the left and right knee regions of the passenger P to be restrained effectively.

In particular, the second chamber 36 is expanded and deployed from the upper portion of the rear wall 34B of the first chamber 34, and restrains at least the left and right knee regions of the passenger P. This thereby enables an increase in capacity of the airbag 32 to be better suppressed than when configured with the single airbag 32 (lacking the first chamber 34 and the second chamber 36). Namely, an increase in output of the inflator 28 can be suppressed, enabling a commensurate reduction in manufacturing cost.

### Fourth Exemplary Embodiment

Description follows regarding a fourth exemplary embodiment. Note that the same reference numerals will be appended to similar sites to those of the first exemplary embodiment to the third exemplary embodiment described above, and detailed explanation thereof (including of common operation and advantageous effects) will be omitted as appropriate.

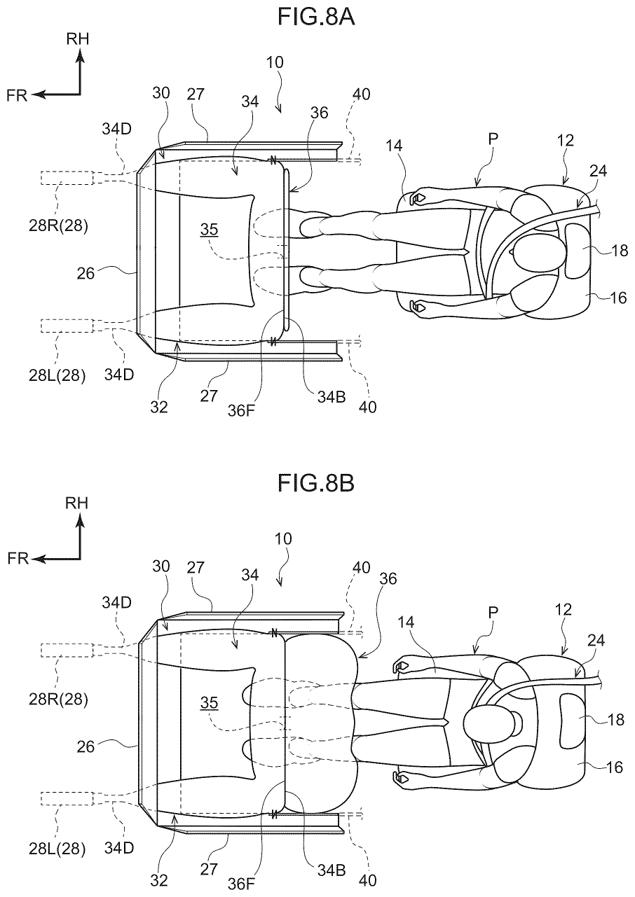

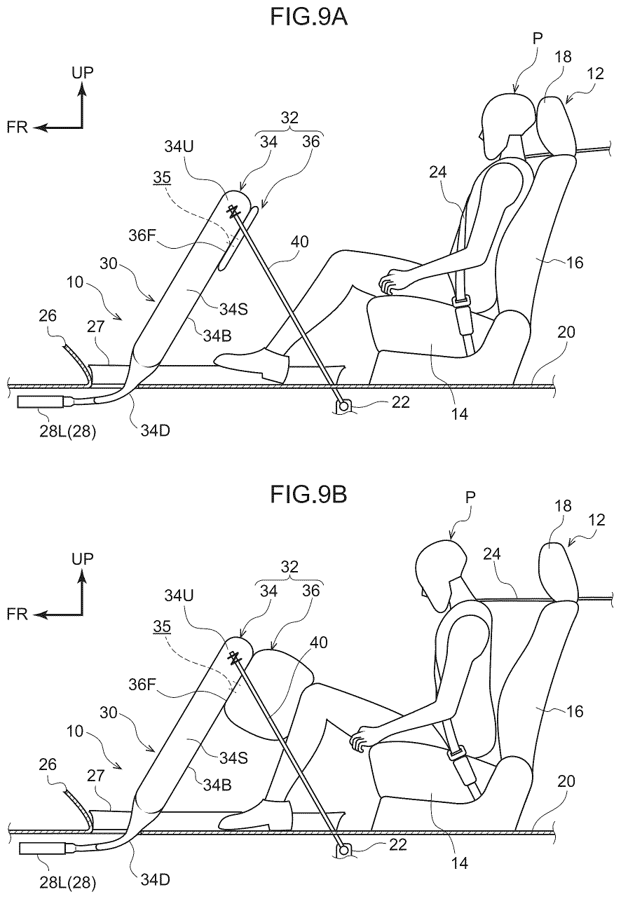

As illustrated in FIG. 8A to FIG. 9B, the fourth exemplary embodiment differs from the third exemplary embodiment described above in that, similarly to in the second exemplary embodiment described above, a left-right pair of inflators 28 is provided so as to supply gas respectively to left-right direction end portions of lower end portions 34D of a first chamber 34.

Namely, similarly to in the second exemplary embodiment described above, there are two individual inflators 28 provided, an inflator 28L on the left side and an inflator 28R on the right side. This means that the lower end portion 34D of the first chamber 34 is formed in a shape branched left and right in a bifurcated shape in plan view. Namely, the inflators 28L, 28R are respectively connected to the left and right lower end portions 34D of the first chamber 34 branched in a bifurcated shape.

The thus configured fourth exemplary embodiment obtains similar operation and advantageous effects to those of the third exemplary embodiment described above, and is also, similarly to in the second exemplary embodiment described above, the fourth exemplary embodiment is able to achieve full expansion and deployment of the first chamber 34 of the airbag 32 at an earlier stage than cases in which, for example, there is only a single inflator 28 provided, and is also able to achieve full expansion and deployment of the second chamber 36 of the airbag 32 at an earlier stage than in such cases.

### Fifth Exemplary Embodiment

Next description follows regarding a fifth exemplary embodiment. Note that the same reference numerals will be appended to similar sites to those of the first exemplary embodiment to the fourth exemplary embodiment described above, and detailed explanation thereof (including of common operation and advantageous effects) will be omitted as appropriate.

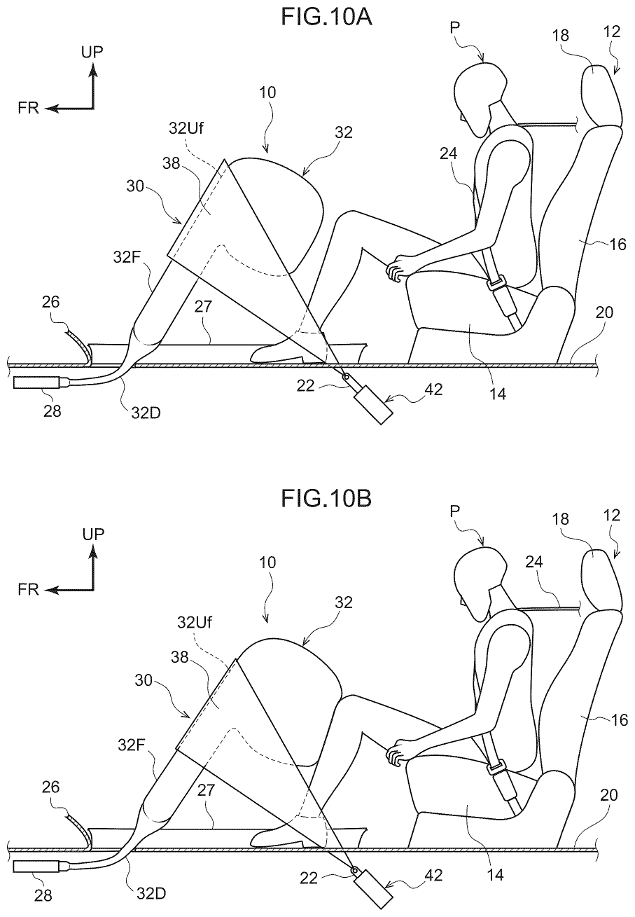

As illustrated in FIG. 10A and FIG. 10B, the fifth exemplary embodiment differs from the first exemplary embodiment in that a pre-tensioner mechanism 42 for pulling the sheet tether 38 when actuated is provide to each of the left-right pair of support sections 22, in a configuration in which each of the pre-tensioner mechanisms 42 is actuated accompanying deployment of the airbag 32 and the sheet tether 38 in a case in which the vehicle seat 12 is positioned at a specific position or further toward the vehicle rear side thereof.

The pre-tensioner mechanism 42 is a known mechanism and may, for example, include a gas generator (omitted in the drawings), and a movement mechanism (omitted in the drawings) to move instantaneously diagonally rearward toward the lower side on actuation of the gas generator. Conceivably this movement mechanism is, for example, a mechanism configured by a rack and pinion. The support sections 22 attached to the lower end portions of the sheet tether 38 are then mechanically connected to this movement mechanism.

Thus in a configuration such that each gas generator is actuated at a timing when at least the left and right knee regions of the passenger P are restrained by the expanded and deployed airbag 32, each of the movement mechanisms are moved instantaneously diagonally rearward toward the lower side by actuation of the gas generators, enabling the sheet tether 38 to be pulled in instantancously diagonally rearward toward the lower side through the support sections 22.

The thus configured fifth exemplary embodiment is, as illustrated, able to bring the expanded and deployed airbag 32 nearer to at least the left and right knee regions of the passenger P than in the first exemplary embodiment to the fourth exemplary embodiment even in a case in which the vehicle seat 12 is positioned at the specific position (for example the positions illustrated in FIG. 2 to FIG. 9) or further toward the vehicle rear side thereof, enabling at least the left and right knee regions of the passenger P to be effectively restrained.

Although the floor mounted lower limb restraint airbag device 30 according to the present exemplary embodiments has been described with reference to the drawings, the floor mounted lower limb restraint airbag device 30 according to the present exemplary embodiment is not limited to the illustrated embodiments thereof, and appropriate design changes may be implemented within a range not departing from the spirit of the present disclosure.

For example, instead of the tear line 20A and the tear lines 20B, an airbag door 26 and a tether door 27 that are configured so as to be rotatable may be pre-installed to the floor 20. Moreover, the floor 20 may be a floor carpet instead of a floor panel. In such cases the module case may be installed at an upper side of the floor panel (between the floor panel and the floor carpet), and the tear lines formed in the floor carpet.

Moreover, the tension member in the second exemplary embodiment to the fourth exemplary embodiment may be a sheet tether 38 instead of the strap tethers 40. Moreover, the tension member in the first exemplary embodiment and the fifth exemplary embodiment may be strap tethers 40 instead of the sheet tether 38. Moreover, the left-right pair of support sections 22 in the second exemplary embodiment to the fourth exemplary embodiment may be respectively provided with pre-tensioner mechanisms 42. Moreover, in the fifth exemplary embodiment a configuration may be adopted such that the left-right pair of support sections 22 is instantaneously pulled in diagonally rearward and toward the lower side by a single pre-tensioner mechanism 42.

What is claimed is:

1. A floor mounted lower limb restraint airbag device comprising:
an airbag installed at a lower side of a floor of a vehicle cabin, configured to rupture the floor by being supplied with gas from an inflator during a vehicle head-on collision, and configured to be expanded and deployed toward at least knee regions of a passenger seated in a vehicle seat; and
a tension member coupling an upper portion of the airbag with a support section provided at a lower side of the floor, the tension member rupturing the floor and deploying accompanying expansion and deployment of the airbag, and the tension member pulling the upper portion of the airbag at a vehicle rear side and relatively toward a vehicle lower side in a case in which at least the knee regions of the passenger, who begins to move toward a vehicle front side under inertia, are restrained by the airbag.

2. The floor mounted lower limb restraint airbag device of claim 1, wherein the airbag and the tension member are configured to be deployed by breaking rupture-break portions formed at the floor.

3. The floor mounted lower limb restraint airbag device of claim 1, wherein the tension member is formed by a sheet tether that covers at least an upper half of a front wall of the expanded and deployed airbag from a vehicle front side.

4. The floor mounted lower limb restraint airbag device of claim 1, wherein the tension member is configured by a pair of strap tethers disposed spaced apart from each other in a vehicle width direction, and having one-end portions thereof attached to the upper portion of the airbag and other-end portions thereof attached to support sections.

5. The floor mounted lower limb restraint airbag device of claim 1, wherein the inflator is a single inflator provided so as to supply a gas to a central portion, in a vehicle width direction, of the airbag.

6. The floor mounted lower limb restraint airbag device of claim 1, wherein the inflator is configured by a pair of inflators provided spaced apart from each other in a vehicle width direction so as to supply the gas respectively to two end portions, in the vehicle width direction, of the airbag.

7. The floor mounted lower limb restraint airbag device of claim 1, wherein:
a pre-tensioner mechanism to pull the tension member on being actuated is provided at the support section; and
the pre-tensioner mechanism is configured so as to be actuated accompanying deployment of the airbag and the tension member in a case in which the vehicle seat is positioned at a specific position or further toward a vehicle rear side than the specific position.

8. The floor mounted lower limb restraint airbag device of claim 1, wherein:
the airbag includes:
a first chamber that is configured to be expanded and deployed toward a vehicle upper side at a vehicle rear side by being supplied with the gas from the inflator, and
a second chamber that is configured to be expanded and deployed toward at least the knee regions of the passenger by being supplied with the gas from the first chamber; and
the tension member couples an upper portion of the first chamber to the support section.

9. The floor mounted lower limb restraint airbag device of claim 8, wherein the second chamber is configured to be expanded and deployed from an upper portion of a rear wall of the first chamber and is configured to restrain at least the knee regions of the passenger.
